(19) United States
(12) Patent Application Publication
(10) Pub. No.: US 2026/0350633 A1
(43) Pub. Date: Nov. 5, 2026

(54) REGULATORY-COMPLIANT WRAPPER FOR PREDICTION MARKET CONTRACTS IN INSTITUTIONAL FINANCIAL INFRASTRUCTURE

(71) Applicant: George William Bickerstaff, III, Greenwich, CT (US)

(72) Inventor: George William Bickerstaff, III, Greenwich, CT (US)

(21) Appl. No.: 19/730,839

(22) Filed: Jul. 3, 2026

Related U.S. Application Data
(60) Provisional application No. 64/044,058, filed on Apr. 20, 2026.

(51) Int. Cl. G06Q 30/018; G06Q 40/04; H04L 9/32

(52) U.S. Cl. CPC G06Q 30/018; G06Q 40/042; H04L 9/3218

(57) ABSTRACT

The invention provides a hardware-attested compliance wrapper for regulated prediction-market contracts. Native event-contract specifications, position records, and KYC data are processed inside a trusted execution environment under sealed, versioned rule sets. The system produces a wrapped instrument definition documenting institution-consumable compliance treatment of the native contract, assigns capital-treatment and reporting attributes, generates regulatory-reporting records, and emits a compliance attestation record binding the input commitments, rule-set versions, decision-tree path, capital methodology, reporting-schema transformation, and wrapped output to a hardware measurement. The resulting record can be independently verified by an institutional counterparty, regulator, supervisor, or reporting endpoint without relying on representations of the prediction-market exchange operator. The compliance attestation record includes the applied jurisdictional decision-tree path and the reporting-schema transformation log, enabling a relying party to independently reproduce the classification and reporting outputs from the committed rule-set data.

### CROSS-REFERENCE TO RELATED APPLICATIONS

This application claims the benefit of U.S. Provisional Patent Application No. 64/044,058, filed Apr. 20, 2026, under USPTO Customer Number 212041, the entire disclosure of which is incorporated herein by reference. This application is further related to, and incorporates by reference in its entirety for all purposes including hardware trusted execution environment architectures, remote attestation primitives, trade surveillance, insider-risk flagging, and signal-weighted probability computations, the U.S. Provisional Patent Application titled Hardware-Attested Trade Integrity System for Regulated Prediction Market Exchanges (the “HATIS companion application”) and the U.S. Provisional Patent Application titled Verified Prediction Confidence Scoring Engine for Signal-Weighted Probability Extraction in Regulated Prediction Market Exchanges (the “VPCS companion application”), each filed concurrently with the above-referenced provisional application under USPTO Customer Number 212041. This application is further related to, and incorporates by reference in its entirety, the portfolio of applications filed under USPTO Customer Number 212041, including without limitation U.S. patent application Ser. Nos. 19/305,912, 19/307,191, 19/308,163, 19/309,743, 19/310,149, 19/377,771, 19/437,146, and 19/547,066, to the extent that said applications teach cryptographic attestation, federated governance, influence-graph analysis, and regulated-capital-markets compliance primitives applicable to the present subject matter.

### FIELD OF THE INVENTION

The present invention relates to regulated financial instrument structuring, and more particularly to regulatory-compliant wrapper systems and methods that produce, for a native prediction market contract, a wrapped instrument definition documenting institutionally consumable compliance treatment suitable for balance-sheet holding, intermediation, and reporting by prudentially regulated entities, by applying within a hardware trusted execution environment automated know-your-customer and anti-money-laundering screening, jurisdictional rule enforcement, position-limit controls, Basel-aligned capital treatment mapping, and standardized regulatory reporting transformation, and by producing cryptographically attested compliance outputs that are independently verifiable by regulators, supervisors, and institutional counterparties against a hardware-vendor attestation service without reliance on representations of the prediction market exchange operator.

### BACKGROUND OF THE INVENTION

Prediction market exchanges have transitioned rapidly into regulated financial infrastructure. In July 2025 (announced Jul. 21, 2025), Polymarket acquired QCEX, comprising the CFTC-registered QCX LLC derivatives exchange and QC Clearing LLC clearinghouse, for approximately $112 million. On Nov. 24, 2025, the Commodity Futures Trading Commission issued an Amended Order of Designation to QCX LLC (operating under the business name Polymarket US), announced publicly on Nov. 25, 2025, permitting operation as an intermediated Designated Contract Market under the Commodity Exchange Act and enabling futures commission merchant intermediation, traditional brokerage onboarding, and Part 16 regulatory reporting. Competing venues, including KalshiEX LLC, continue to scale event contracts across economic, political, and sports outcomes. Institutional participants, including hedge funds, proprietary trading firms, banks, and asset managers, have disclosed market-making and directional positions in such contracts.

Regulated status imposes compliance obligations substantially equivalent to those governing traditional derivatives markets. Institutional entities are subject to Basel capital frameworks, CFTC reporting requirements under 17 C.F.R. Part 16 (trade and volume reporting by contract markets) and 17 C.F.R. Part 17 (large-trader reporting), and, where a contract is classified as a swap, 17 C.F.R. Part 45 (swap data reporting to registered Swap Data Repositories). Such entities are further subject to SEC broker-dealer net capital rules under Rule 15c3-1 of the Securities Exchange Act of 1934, and to anti-money-laundering obligations under the Bank Secrecy Act and CFTC anti-money-laundering rules.

Against that regulatory backdrop, institutional entities cannot readily acquire, hold, or intermediate raw prediction market event contracts without documented satisfaction of know-your-customer and anti-money-laundering screening, sanctions compliance, jurisdictional eligibility rules, position limits, concentration controls, and standardized regulatory reporting appropriate to the contract's regulatory classification. Manual compliance overlays and software-only compliance processing performed on exchange-operator-controlled infrastructure do not scale to institutional volumes and do not satisfy the supervisory documentation requirements of prudentially regulated counterparties. Those requirements typically do not permit reliance on representations of the exchange operator or of software audit firms as the sole basis for counterparty-level compliance documentation.

Recent CFTC enforcement activity and rulemaking underscore the urgency. On Feb. 25, 2026, the CFTC's Division of Enforcement issued a Prediction Markets Advisory (Release 9185-26) following the public release of two disciplinary actions brought by a Designated Contract Market against market participants involving misuse of nonpublic information and fraud with respect to event contracts, confirming the Commission's authority to investigate and prosecute violations of the Commodity Exchange Act by participants in prediction markets and emphasizing coordination between the Commission and DCMs regarding referral of potential violations for investigation. On Mar. 12, 2026, the CFTC's Division of Market Oversight issued CFTC Staff Advisory Letter No. 26-08, a staff advisory addressed to DCMs detailing the Division's current views on the regulations applicable to the listing and trading of event contracts, and the Commission concurrently published an Advance Notice of Proposed Rulemaking requesting comment on the regulation of event contracts and prediction markets. Collectively, these regulatory developments confirm that Designated Contract Markets have independent duties under CEA DCM Core Principle 3 (contracts not readily susceptible to manipulation), Core Principle 4 (market monitoring and prevention of manipulation), and Core Principle 12 (protection of market participants) to maintain audit trails, conduct surveillance, and enforce rules against prohibited practices, including misappropriation-based insider trading under CFTC Rule 180.1 and CEA Section 6(c)(1). No existing system provides a standardized, institutionally auditable wrapper that automatically transforms native prediction market contracts into compliant wrapped instrument definitions while producing regulator-verifiable, hardware-attested evidence of the applied compliance processing.

This deficiency impedes institutional adoption. A bank, broker-dealer, asset manager, central bank, sovereign wealth fund, or pension fund risk desk requires verifiable documentation that a prediction market position satisfies applicable regulatory regimes, can be reported accurately to CFTC-registered swap data repositories, where applicable, and receives appropriate capital treatment under frameworks such as the Standardized Approach for Counterparty Credit Risk (SA-CCR) for derivatives exposures. Such institutions operate under model risk management frameworks—including but not limited to the Basel Committee principles on model risk management, OECD principles on prudential supervision, the U.S. federal banking agencies' SR 11-7 supervisory guidance on model risk management, and sovereign-level internal governance frameworks—that do not permit reliance on representations of an external operator or of a software audit firm regarding the integrity of inputs to internal models and regulatory computations. The present invention addresses these needs by providing a regulatory-compliant wrapper that ingests native contract specifications and position records within a hardware trusted execution environment, applies committed layered compliance logic, maps to wrapped instrument definitions with derivative instrument treatment as applicable under the Commodity Exchange Act or the Securities Exchange Act of 1934 consistent with the contract's regulatory designation, generates required regulatory reporting records, assigns Basel-aligned capital treatment attributes, and produces cryptographically attested compliance outputs verifiable by regulators, supervisors, and institutional counterparties against a hardware-vendor attestation service. Integration with the HATIS companion application (for trade integrity surveillance findings and linkage analysis) and the VPCS companion application (for signal-weighted probabilities and insider-risk flags) enables risk-adjusted, attestable wrapping.

Certain background technologies are known to the applicant. Reference is made by way of background to CFTC DCM Core Principles 3, 4, and 12 codified at CEA Section 5(d); 17 C.F.R. Parts 16, 17, and 45; SEC broker-dealer net capital rules under Exchange Act Rule 15c3-1; Basel III finalized reforms (including the Standardized Approach for Counterparty Credit Risk) as set forth in Basel Committee Publication 279 and implemented under applicable U.S. federal banking agency capital rules; federal banking agency supervisory guidance including SR 11-7 on model risk management; and hardware trusted execution environment attestation primitives as described in the HATIS and VPCS companion applications. No admission is made that any referenced technology constitutes prior art against the claims presented herein, and the applicant reserves the right to address any particular reference through an Information Disclosure Statement filed in accordance with 37 C.F.R. § 1.98 upon conversion to a non-provisional application.

Other approaches integrate blockchain-originated derivative instruments, including prediction-market-type contracts, with traditional broker-dealer trading and settlement infrastructure, such as by matching orders and recording customer trading activity on an immutable ledger for governing-body and regulator visibility. Such approaches do not teach a hardware-sealed, version-committed rule set governing compliance determinations; a cryptographic transformation log binding capital-treatment and regulatory-reporting outputs to the specific rule-set versions and input commitments from which they were derived; or a hardware-rooted compliance attestation record independently verifiable by a regulator or institutional counterparty against a hardware-vendor attestation service without reliance on representations of the operator of the blockchain-integrated trading platform itself. The present invention addresses compliance-processing integrity at the hardware-attestation layer, a distinct problem from order matching, trade settlement, and broker-dealer-ecosystem integration addressed by such approaches. No admission is made that any reference discussed in this paragraph constitutes prior art against the claims presented herein, and applicant reserves the right to address any particular reference through an Information Disclosure Statement filed in accordance with 37 C.F.R. § 1.98.

### SUMMARY OF THE INVENTION

The present invention provides regulatory-compliant wrapper systems, methods, and non-transitory computer-readable media for prediction market contracts, enabling seamless integration into institutional financial infrastructure through hardware-anchored compliance processing whose outputs are cryptographically verifiable by regulators, supervisors, and institutional counterparties without reliance on representations of the prediction market exchange operator.

In a first aspect, a regulatory-compliant wrapper system comprises at least one compliance processing engine having a hardware measurement register and a hardware-rooted attestation key, instantiated within a hardware trusted execution environment configured to load a measured compliance code base such that the contents of the hardware measurement register cryptographically bind to the loaded code base upon instantiation; a native data intake interface delivering native prediction market contract specifications and associated position records into the hardware trusted execution environment over encrypted channels terminating within the hardware trusted execution environment; a know-your-customer and anti-money-laundering screening module applying automated screening against a committed rule set; a jurisdictional mapping module enforcing eligibility and structuring rules by jurisdiction and transforming the native contract into a wrapped instrument definition with derivative instrument treatment attributes as applicable under the Commodity Exchange Act or the Securities Exchange Act of 1934 consistent with the contract's regulatory designation; a capital treatment mapping module assigning Basel-aligned exposure attributes including potential future exposure calculations under the Standardized Approach for Counterparty Credit Risk; a reporting transformation module generating regulatory reporting records compliant with 17 C.F.R. Parts 16, 17, and 45 or equivalent foreign schemas; and an attestation module producing a compliance attestation record cryptographically signed by the hardware-rooted attestation key and binding the wrapped instrument attributes to the applied rule sets, input records, and processing methodology, independently verifiable against a hardware-vendor attestation service.

In a second aspect, a method of producing a regulatory-compliant wrapped prediction market instrument comprises loading a measured compliance code base into a hardware trusted execution environment; ingesting native prediction market contract specifications and position records over encrypted channels terminating within the hardware trusted execution environment; applying know-your-customer, anti-money-laundering, sanctions, and eligibility screening against a committed rule set; mapping the contract to a jurisdiction-appropriate wrapped instrument definition with derivative instrument treatment attributes; assigning Basel-aligned capital treatment attributes including potential future exposure under the Standardized Approach for Counterparty Credit Risk; generating regulatory reporting records; producing a compliance attestation record cryptographically signed by a hardware-rooted attestation key and binding the wrapped instrument attributes to the applied rule sets and input records; and exporting the wrapped instrument, capital treatment attributes, regulatory reporting records, and compliance attestation record in a form independently verifiable by a regulator or institutional counterparty against a hardware-vendor attestation service.

In a third aspect, a non-transitory computer-readable medium stores program instructions that, when executed within a hardware trusted execution environment, cause performance of the method of the second aspect.

Further aspects include, without limitation: hardware trusted execution environment anchoring for attested compliance processing; integration with trade-integrity surveillance findings from the HATIS companion application and signal-weighted probability outputs from the VPCS companion application for risk-adjusted wrapping; automated position-limit and concentration-risk enforcement; zero-knowledge-proof accompaniment of exported compliance records for privacy-preserving institutional disclosure; cryptographic commitment of compliance attestation records to a Merkle-accumulator tamper-evident ledger whose root is published to an external public commitment channel; differential-privacy-protected aggregate outputs with noise parameters committed to the attestation record; and cross-portfolio integration with existing Basel III finalized-reforms compliance primitives in the applicant's portfolio filed under USPTO Customer Number 212041.

In a further aspect, the present invention operates as the compliance layer of an integrated three-system hardware-attested infrastructure stack for regulated prediction market exchanges, the stack comprising: (i) the HATIS companion application providing hardware-attested trade integrity surveillance (trust layer); (ii) the VPCS companion application providing hardware-attested signal-weighted probability extraction (signal layer); and (iii) the present invention providing hardware-attested institutional compliance bridging (compliance layer). The three systems share a common root of trust through federated hardware attestation and jointly produce a cryptographic chain of custody from trade execution through probability characterization through institutional consumption, supporting documentation for compliance with DCM Core Principles 3, 4, and 12, CFTC Rule 180.1, and applicable Basel capital framework obligations through a unified cryptographic verification pathway.

The foregoing summary is illustrative and is not intended to limit the scope of the claims appended hereto.

### BRIEF DESCRIPTION OF THE DRAWINGS

The disclosure is illustrated by way of example and not by way of limitation. The drawings are organized as five figure groups, each comprising five subfigures, designated FIG. 1A through FIG. 5E. The drawings employ descriptive labels for components and do not rely upon reference numerals; like labels indicate like components throughout.

FIG. 1 depicts the Regulatory-Compliant Wrapper System Architecture, in subfigures FIG. 1A through FIG. 1E.

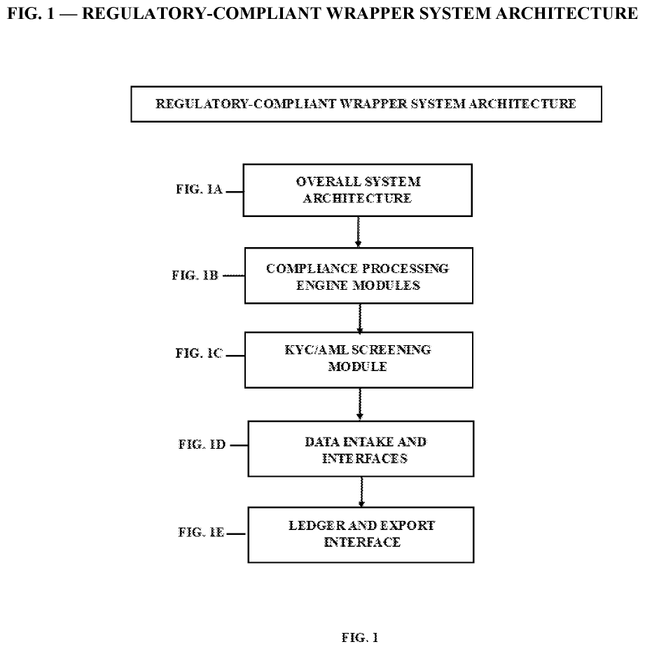

FIG. 2 depicts the Wrapped Instrument Production Method, in subfigures FIG. 2A through FIG. 2E.

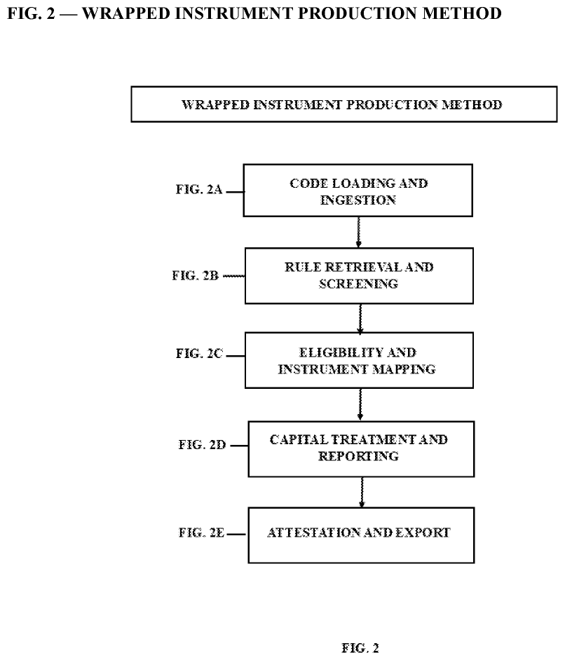

FIG. 3 depicts the Jurisdictional Rule Mapping Transformation, in subfigures FIG. 3A through FIG. 3E.

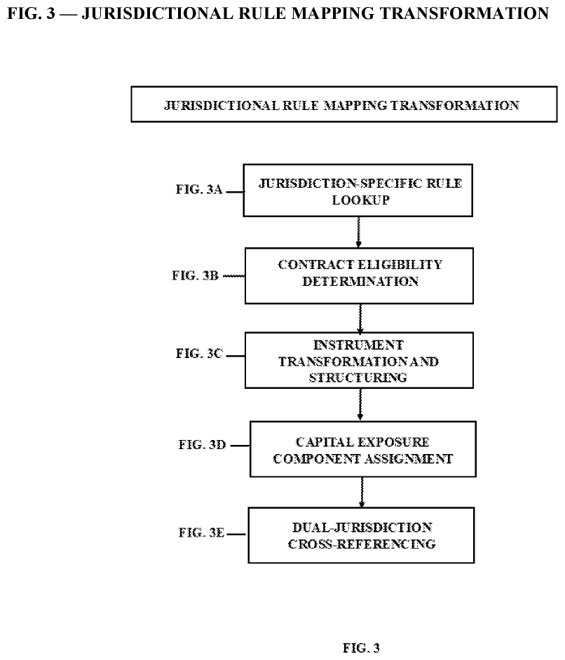

FIG. 4 depicts the Compliance Attestation and Ledger, in subfigures FIG. 4A through FIG. 4E.

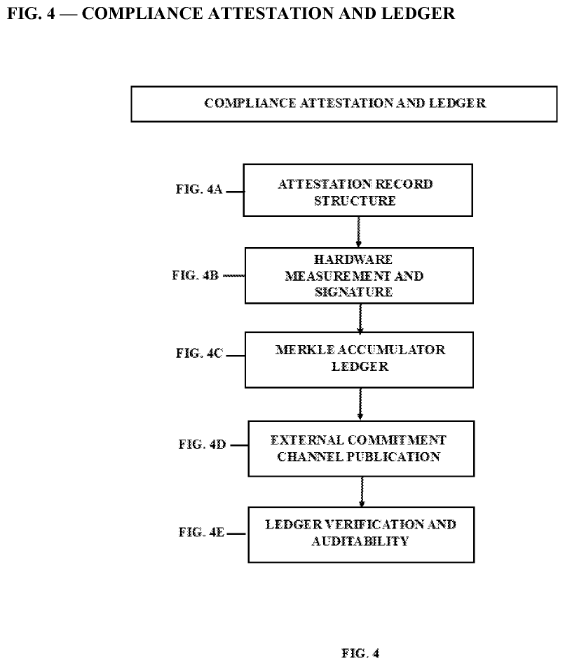

FIG. 5 depicts the Regulatory Export and Integration, in subfigures FIG. 5A through FIG. 5E.

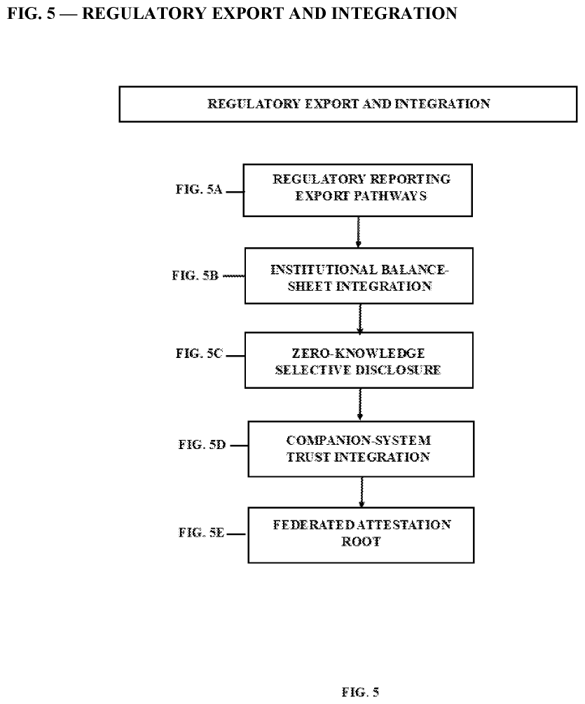

### DETAILED DESCRIPTION OF THE INVENTION

### A. Overview and Terminology

As used herein, the term “attestation quote” refers to a cryptographic assertion, signed by a hardware-rooted attestation key, that binds a hardware measurement register value to a specified payload such that the payload's association with a specific, unmodified compliance code base is independently verifiable against a hardware-vendor attestation service.

As used herein, the term “capital mapping methodology” refers to a committed, version-identified set of computational parameters and formulas—including without limitation a replacement cost formula, a potential future exposure formula, a supervisory factor table, and an alpha multiplier—applied to a wrapped instrument definition to produce capital treatment attributes, wherein the specific parameters and formulas in force during a given computation are cryptographically fixed and independently verifiable.

As used herein, the term “committed rule set” refers to a version-identified set of rule parameters—including without limitation KYC/AML thresholds, jurisdictional eligibility criteria, capital mapping methodology parameters, and reporting schema mappings—that is sealed to the hardware identity of a hardware trusted execution environment and whose version identifier is committed to a compliance attestation record, such that the specific rule parameters in force during a given computation are cryptographically fixed and independently verifiable.

As used herein, the term “compliance attestation record” refers to a cryptographically signed record produced within or bound to a hardware trusted execution environment that attests to the application of specified compliance rules-KYC/AML and sanctions rules, jurisdictional eligibility and structuring rules, capital treatment methodology, and regulatory reporting schemas-to specified input records to produce a specified wrapped instrument definition, and that is independently verifiable against a hardware-vendor attestation service without reliance on representations of the prediction market exchange operator, the compliance software vendor, or any party other than the hardware vendor.

As used herein, the term “hardware measurement register” refers to a hardware-maintained register, internal to a hardware trusted execution environment, whose contents are set by the hardware itself upon instantiation of a code base such that the register's contents constitute a cryptographic measurement of the loaded code base, any modification of which produces a different register value detectable by a relying party.

As used herein, the term “hardware-rooted attestation key” refers to a cryptographic key provisioned to a hardware trusted execution environment by the hardware vendor and usable only within the hardware boundary for the purpose of producing attestation quotes that chain to the hardware vendor's attestation service.

As used herein, the term “hardware trusted execution environment” or “TEE” refers to a hardware-enforced isolated execution context supported by a general-purpose processor or equivalent hardware, the integrity of whose contents is measurable by the hardware itself and attestable remotely through a cryptographic quote signed by a key rooted in the hardware, as further described in the HATIS and VPCS companion applications. Non-limiting examples of TEE technologies include Intel Software Guard Extensions, Intel Trust Domain Extensions, AMD Secure Encrypted Virtualization with Secure Nested Paging, ARM Confidential Compute Architecture, IBM Secure Execution for Linux, and any equivalent or successor confidential computing architecture providing hardware-rooted measurement, isolation, and remote attestation.

As used herein, the term “hardware-vendor attestation service” refers to a verification service, operated by or on behalf of a hardware trusted execution environment vendor, that independently verifies an attestation quote against a hardware-vendor root certificate without reliance on representations by the operator of the system producing the attestation quote.

As used herein, the term “jurisdictional rule set” refers to a committed rule set, specific to a designated jurisdiction or regulatory regime, comprising eligibility determinations, permitted contract-type classifications, structuring parameters, and reporting-schema identifiers applicable to prediction market contracts within that jurisdiction.

As used herein, the term “prediction market contract” refers to any instrument traded on a prediction market exchange whose payout is contingent on the occurrence or non-occurrence of a specified future event, including without limitation binary option contracts, categorical event contracts, scalar outcome contracts, and hybrid variants, and including event contracts listed on Designated Contract Markets under the Commodity Exchange Act, event contracts listed on registered securities exchanges under the Securities Exchange Act of 1934, and event contracts listed on equivalent foreign regulated venues.

As used herein, the term “regulatory-compliant wrapper” refers to a system and method that ingests a native prediction market contract and produces a wrapped instrument definition documenting the classification, reporting, capital treatment, and compliance requirements applicable to the native prediction market contract for prudentially regulated entities, producing institution-specific treatment attributes assigned under a committed jurisdictional rule set, wherein said treatment attributes identify the regulatory designation applicable to the contract under the Commodity Exchange Act, the Securities Exchange Act of 1934, or an equivalent foreign regulatory regime, and producing a compliance attestation record binding the wrapped instrument attributes to the applied compliance methodology. The term does not assert, and shall not be construed to assert, any particular regulatory classification of a prediction market contract beyond the classification identified in the committed jurisdictional rule set as in force during the computation. The system applies the committed rule set as configured and does not itself make an independent legal determination of regulatory classification, capital treatment, or reporting obligation except as encoded in the committed rule set; responsibility for the correctness of a committed rule set as applied to a particular jurisdiction or regulatory regime rests with the party or parties configuring said rule set.

As used herein, the term “tamper-evident methodology ledger” refers to an append-only data structure, organized as a Merkle accumulator, that stores compliance attestation records and associated wrapped instrument definitions as leaves and periodically publishes an accumulator root to an external public commitment channel, such that retroactive alteration of any stored record is detectable by comparison against a previously published root.

As used herein, the term “treatment attributes” refers to a set of data values, assigned to a wrapped instrument definition under a jurisdictional rule set, that identify the regulatory designation, contract-type treatment, and structuring parameters applicable to a wrapped prediction market instrument, including without limitation designation under the Commodity Exchange Act, the Securities Exchange Act of 1934, or an equivalent foreign regulatory regime.

As used herein, the term “wrapped instrument definition” refers to the data structure produced by the system of the present invention that specifies the regulatory classification, contract-type treatment, notional amount, settlement mechanics, margining parameters, capital treatment attributes, and reporting metadata sufficient for institutional balance-sheet recognition, supervisory documentation, and regulatory reporting of a wrapped prediction market instrument.

### A1. Threat Model

The system protects the integrity of compliance processing against: (i) manipulation by an operator of the prediction market exchange, including alteration of native contract specifications, position records, or participant-identity records prior to or during ingestion; (ii) alteration of compliance attestation records, wrapped instrument definitions, or regulatory reporting records by any party after production, including a software-only audit or reporting process operating outside the hardware trusted execution environment; (iii) tampering with a regulatory reporting record after its production and prior to delivery to a reporting endpoint; and (iv) substitution of a committed rule set, committed capital mapping methodology, or committed reporting schema mapping with an unauthorized or unattested version. The system's protection against the foregoing threat vectors is provided at the level of the hardware trusted execution environment's isolation and measurement guarantees; the system does not itself provide protection against side-channel attacks on the underlying hardware (e.g., power analysis, cache-timing, or speculative-execution side channels) or against supply-chain compromise of the underlying hardware or firmware prior to deployment, protection against which is provided, to the extent provided at all, by the hardware vendor's own security architecture and manufacturing controls and is outside the scope of the present invention. The system does not protect against, and does not assert protection against, incorrect configuration of a committed rule set by the party or parties authorized to configure it—that is, the system faithfully and verifiably applies a committed rule set as configured, but does not independently determine whether a given committed rule set correctly reflects applicable law or regulation in a particular jurisdiction. Mitigation of hardware-level side-channel and supply-chain risks relies on the hardware vendor's certified implementations (e.g., security certifications applicable to Intel Trust Domain Extensions or AMD Secure Encrypted Virtualization with Secure Nested Paging) and on proper deployment practices, and is outside the scope of protections provided by the present invention.

### B. System Architecture

A regulatory-compliant wrapper system according to one embodiment includes a hardware trusted execution environment having a hardware measurement register and a hardware-rooted attestation key; a compliance processing engine executing within the hardware trusted execution environment and comprising a KYC/AML screening module, a jurisdictional mapping module, a capital treatment mapping module, a reporting transformation module, and an attestation module, all of which execute within the TEE boundary; a native data intake interface; a companion-integration interface through which surveillance findings from the HATIS companion application and signal-weighted probability outputs from the VPCS companion application are delivered into the hardware trusted execution environment; a tamper-evident methodology ledger; and an institutional export interface. Plaintext of participant-identity records, native contract specifications, and committed rule sets is not exposed outside the hardware trusted execution environment during wrapper processing, except as cryptographic commitments or as authorized, specifically configured exports; native contract specifications and committed rule sets may exist in plaintext outside the hardware trusted execution environment prior to ingestion or configuration, such as at their originating source or at a rule-set governance authority. The compliance code base executing within the hardware trusted execution environment is measured by hardware upon instantiation, producing a measurement value that is incorporated into subsequent attestation quotes issued by the attestation module. The system is not limited to any particular hardware vendor or trusted execution environment technology; the hardware measurement register, hardware-rooted attestation key, and attestation quote generation and verification interfaces are abstracted through a hardware-attestation adapter layer configured for the specific underlying TEE technology—for example, an abstraction layer that normalizes attestation-quote generation and verification calls across Intel Trust Domain Extensions, AMD Secure Encrypted Virtualization with Secure Nested Paging, and other TEE technologies into a common interface—such that the compliance processing engine and its constituent modules operate identically across different hardware vendors and TEE technologies. The system may be deployed on single-tenant bare-metal servers with TEE-equipped processors, confidential-compute virtual machines offered by cloud infrastructure providers, or hybrid deployments combining on-premises TEE-equipped servers with cloud-hosted attestation-verification services.

### C. KYC/AML and Screening Module

The KYC/AML screening module derives pseudonymized participant identifiers as a committed cryptographic hash function (in one non-limiting embodiment, SHA-256, or an equivalent or successor collision-resistant hash function identified by the committed rule set) applied to the plaintext know-your-customer attestation data, with the specific hash algorithm and parameters identified by the committed rule set committed to the compliance attestation record, such that a relying party possessing the same plaintext data and the committed hash function identifier can independently reproduce and verify a given pseudonymized identifier without access to any other participant's plaintext data. The KYC/AML screening module, executing within the hardware trusted execution environment, applies automated screening using participant-identity records, watchlist and sanctions data, and optional linkage fingerprints received through the companion-integration interface from the HATIS companion application. Screening incorporates name/address matching against watchlist and sanctions lists, graph-based linkage analysis leveraging HATIS-derived account-linkage fingerprints, verification of KYC attestations from regulated futures commission merchants, and composite risk scoring. The rule set in force during the screening computation is sealed to the hardware identity of the hardware trusted execution environment and its version identifier is committed to the compliance attestation record. The following pseudocode illustrates an exemplary screening procedure:

```
PROCEDURE PerformKYCScreening(participant_id, position_record,
    kyc_attestation, sanctions_list, linkage_fingerprint,
    rule_set_version):
  // Fetch sealed rule set
  rules ← UNSEAL(KYCRuleSets[rule_set_version])
  risk_score ← 0.0
  // Sanctions and watchlist matching
  match_score ← match_watchlist(participant_id, sanctions_list)
  IF match_score > rules.watchlist_threshold:
  risk_score ← risk_score + rules.α_watchlist · match_score
// Linkage to high-risk entities via HATIS fingerprints
IF linkage_fingerprint > rules.linkage_threshold:
  risk_score ← risk_score + rules.β_linkage · linkage_fingerprint
// Validation of attested KYC data
IF NOT verify_kyc_attestation(kyc_attestation):
  risk_score ← risk_score + rules.y_unverified
// Disposition
IF risk_score > rules.hard_block_threshold:
  disposition ← HARD_BLOCK
ELSE IF risk_score > rules.soft_flag_threshold:
  disposition ← SOFT_FLAG
ELSE:
  disposition ← PASS
screened_record ← {participant_id, risk_score, disposition,
    screening_timestamp, rule_set_version}
ATTEST(screened_record, input_commitments, rule_set_version)
RETURN screened_record
```

Screening results are logged with cryptographic commitments for auditability. Hard-block and soft-flag thresholds, blending coefficients α, β, γ, and watchlist and linkage thresholds are committed rule-set parameters included in the attestation record. In one embodiment, HARD_BLOCK disposition prevents the wrapped instrument from being produced and generates a regulator-reportable exception record; SOFT_FLAG disposition permits wrapping with elevated capital treatment and enhanced supervisory reporting; PASS disposition permits normal wrapping. All dispositions are attested.

### D. Jurisdictional Mapping and Instrument Transformation

The jurisdictional mapping module, executing within the hardware trusted execution environment, maintains a plurality of jurisdiction-specific rule sets for at least U.S. CEA-designated contract markets under Commodity Exchange Act Section 5, U.S. SEC-registered securities exchanges under the Securities Exchange Act of 1934, U.S. intermediated DCM configurations permitting futures-commission-merchant intermediation, EU-regulated venues operating under applicable European market infrastructure regulations, and equivalent foreign regulatory regimes. Each jurisdictional rule set comprises eligibility determinations, permitted contract-type classifications, structuring parameters, margining and settlement attributes, and reporting-schema identifiers. The following pseudocode illustrates the mapping procedure:

```
PROCEDURE MapToWrappedInstrument(native_contract, jurisdiction,
    regulatory_designation, rule_set_version):
  rules ← UNSEAL(JurisdictionalRuleSets[jurisdiction][rule_set_version])
// Eligibility determination
IF NOT rules.is_eligible(native_contract, regulatory_designation):
  RETURN {eligible: false, reason: rules.rejection_code(...)}
// Contract-type classification
contract_type ← rules.classify(native_contract, regulatory_designation)
// e.g., “cleared_future”, “swap”, “security_future”, “binary_option”
// Structuring attributes
treatment ← rules.treatment(contract_type)
// e.g., “futures-style” (CEA) or “swap-style” (CEA)
// or “security-based” (Exchange Act)
wrapped ← {
  eligible: true,
  jurisdiction: jurisdiction,
  regulatory_designation: regulatory_designation,
  contract_type: contract_type,
  treatment: treatment,
  notional: rules.compute_notional(native_contract),
  maturity: native_contract.maturity,
  settlement: rules.settlement_type(native_contract),
  margin_requirements: rules.margin(contract_type, notional),
  reporting_schema: rules.reporting_schema(contract_type),
  rule_set_version: rule_set_version
}
ATTEST(wrapped, native_contract, jurisdiction, rule_set_version)
RETURN wrapped
```

The rule-engine decision flow within rules.classify and rules.treatment is a committed traversal of a decision structure identified in the committed jurisdictional rule set. In a non-limiting exemplary embodiment, the decision flow proceeds as follows:

```
PROCEDURE ClassifyUnderJurisdictionalRules(native_contract, rules):
  // Traverse the committed decision tree in priority order
  FOR each rule IN rules.decision_tree (priority-ordered) :
    IF rule.applies(native_contract):
      IF rule.is_terminal:
    RETURN (rule.contract_type, rule.treatment_class,
          rule.rule_id, rule.priority_rank)
    ELSE:
      RETURN ClassifyUnderJurisdictionalRules(
          native_contract, rule.subtree)
// No terminal rule matched
RAISE ELIGIBILITY_REJECTION(reason=“no_matching_rule”)
```

Where more than one terminal rule applies, the committed rule set specifies a deterministic precedence order by priority_rank; ties in priority_rank raise a MAPPING_AMBIGUITY exception per paragraph [0027b]. The rule_id and priority_rank of the terminal rule applied are committed to the compliance attestation record, enabling a relying party to independently reproduce the classification from the same rule set and native contract specification.

Mapping assigns attributes necessary for balance-sheet recognition, margining, clearinghouse intermediation, and regulatory reporting under the applicable jurisdiction. In one embodiment, the mapping module is configured to recognize the intermediated DCM designation (as granted to QCX LLC under the Amended Order of Designation of Nov. 24, 2025 and as may be granted to other DCM operators) and to assign wrapped-instrument attributes permitting futures commission merchant intermediation, traditional brokerage onboarding, and Part 16 reporting, consistent with the terms of the designation order. In a further embodiment, the mapping module is configured to produce dual-jurisdiction wrapped instruments covering economically equivalent contracts listed on both a U.S. DCM and a foreign regulated venue, with attested cross-references between the two wrapped-instrument records.

The wrapped instrument definition produced by the jurisdictional mapping module is a versioned data record whose field-level schema is committed to the compliance attestation record through a wrapper_schema_version field. In a non-limiting exemplary embodiment, the field-level schema enumerates, for each wrapped instrument: (i) source identifiers (source_exchange_id, source_contract_id); (ii) regulatory-designation attributes (jurisdiction, regulatory_designation from {DCM_INTERMEDIATED, DCM_DIRECT, SECURITY, FOREIGN_regime_code}, jurisdictional_rule_set_version); (iii) contract-classification attributes (contract_type from {BINARY_OPTION, CATEGORICAL, SCALAR, HYBRID}, treatment_class from {FUTURES_STYLE, SWAP_STYLE, SECURITY_BASED, OTHER}, with enumerated values drawn from committed dictionaries); (iv) economic attributes (notional with ISO 4217 currency code, maturity in ISO 8601, settlement type and mechanism); (v) institutional-treatment attributes (margin_requirements, position_limits, capital_methodology_identifier); (vi) reporting attributes (reporting_schema_identifier resolving under the committed reporting schema mapping); (vii) exception_records per paragraph [0027b]; (viii) companion_system_references (HATIS and VPCS attestation quote identifiers); and (ix) attestation_commitments (cryptographic commitments over input, rule set, and output). Each field carries a type annotation, an optionality flag, and a default value where applicable. The field-level schema is versioned independently from the compliance code base and is forward-compatible. The foregoing schema is illustrative only and does not limit the scope of the claims.

The jurisdictional mapping module, together with the upstream KYC/AML screening module and the downstream capital treatment mapping module and reporting transformation module, implements structured exception handling. Exceptions encountered during compliance processing are classified into exception categories including, without limitation: INGESTION_ERROR, for malformed native contract specifications or position records; SCREENING_HARD_BLOCK, for participant-identity records producing a composite risk score exceeding the committed hard-block threshold; ELIGIBILITY_REJECTION, for native contracts not eligible under any jurisdictional rule set; MAPPING_AMBIGUITY, for native contracts matching rules under more than one jurisdictional regime without a deterministic precedence rule; CAPITAL_METHODOLOGY_UNAVAILABLE, for wrapped instruments whose asset-class classification is not present in the committed supervisory factor table version; REPORTING_SCHEMA_MISMATCH, for wrapped instruments whose reporting schema identifier does not resolve to a supported schema version under the committed reporting schema mapping; COMPANION_SYSTEM_ATTESTATION_FAILURE, for integrated processing where a companion system's attestation quote fails verification against the hardware-vendor attestation service; and ATTESTATION_FAILURE, for failure to produce a valid compliance attestation record. Each exception is itself attested: the exception category, exception timestamp, upstream processing state, and affected input commitment are committed to the compliance attestation record produced for the computation interval, such that downstream consumers receive a hardware-attested record indicating both the exception condition and the processing state at the time the exception was encountered. SCREENING_HARD_BLOCK, ELIGIBILITY_REJECTION, MAPPING_AMBIGUITY, COMPANION_SYSTEM_ATTESTATION_FAILURE, and ATTESTATION_FAILURE exceptions halt production of a wrapped instrument and produce an attested exception record in lieu thereof; CAPITAL_METHODOLOGY_UNAVAILABLE and REPORTING_SCHEMA_MISMATCH exceptions produce a wrapped instrument with reduced treatment scope and an attested exception annotation identifying the unsupported attribute. All exception records are committed to the tamper-evident methodology ledger through hardware-signed writes from within the hardware trusted execution environment.

### E. Capital Treatment Mapping

The capital treatment mapping module, executing within the hardware trusted execution environment, assigns institution-specific capital treatment attributes to each wrapped instrument definition under a committed capital mapping methodology. The committed capital mapping methodology is a versioned, sealed artifact identifying the formulas, parameters, and lookup tables by which replacement cost, asset-class add-ons, maturity adjustments, netting aggregation, and exposure-at-default are computed. In one non-limiting embodiment, the committed capital mapping methodology comprises the formulas and parameter set of the Standardized Approach for Counterparty Credit Risk (SA-CCR) as set forth in Basel Committee Publication 279 and as implemented under applicable U.S. federal banking agency capital rules or equivalent foreign prudential rules. The module outputs capital-treatment attributes suitable for incorporation into bank, broker-dealer, or asset-manager balance-sheet and regulatory capital systems. Integration with the VPCS companion application permits risk adjustment of capital attributes based on attested signal-weighted probability and insider-risk data. The following pseudocode illustrates the capital treatment computation for a single wrapped instrument under a committed capital mapping methodology implementing SA-CCR:

The supervisory factor applied under the committed capital mapping methodology is selected by the committed capital mapping methodology and the applicable supervisory interpretation in force during the computation; for novel asset classes, including prediction market event contracts, for which no supervisory factor has been formally settled by the applicable prudential regulator, the committed capital mapping methodology identifies a designated fallback disposition. In one non-limiting embodiment, the designated fallback disposition comprises at least one of: (i) an exception record, classified as CAPITAL_METHODOLOGY_UNAVAILABLE per paragraph [0027b], produced in lieu of a wrapped instrument capital attribute set; (ii) application of a committed conservative default supervisory factor identified in the committed capital mapping methodology as applicable pending a formal supervisory determination; or (iii) a manual-review flag committed to the compliance attestation record, requesting institution-side or supervisor-side override of the applied supervisory factor prior to reliance on the wrapped instrument's capital attributes. The designated fallback disposition applied to a given wrapped instrument definition, and its basis, are committed to the compliance attestation record.

```
PROCEDURE ComputeCapitalTreatment(wrapped_instrument,
    current_market_value, collateral, netting_set,
    supervisory_factor_table_version, alpha):
  sf_table ← UNSEAL(SupervisoryFactorTable[sf_table_version])
  // Replacement cost (unmargined formula; margined form omitted)
  rc ← max(current_market_value − collateral, 0)
  // Asset-class add-on
  asset_class ← wrapped_instrument.asset_class
  sf ← sf_table[asset_class]
  m ← wrapped_instrument.maturity_years
  maturity_factor ← min(1.0, sqrt(min(m, 1.0) / 1.0))
addon ← wrapped_instrument.notional · sf · maturity_factor
// Aggregation (netting, if permitted)
IF netting_set ≠ NULL AND wrapped_instrument IN netting_set:
  aggregate_addon ← netting_aggregate(netting_set, addon)
ELSE:
  aggregate_addon ← addon
// Potential future exposure (unmargined multiplier = 1)
pfe ← aggregate_addon · 1.0
// Exposure at default
ead ← alpha · (rc + pfe) // alpha = 1.4 per SA-CCR
// Optional VPCS-derived risk adjustment
IF vpcs_calibrated_probability_record AVAILABLE:
  ead ← ead · (1 + rules.δ · vpcs_insider_risk_indicator)
capital_attrs ← {rc, pfe, ead, sf, maturity_factor,
    alpha, sf_table_version, netting_applied}
ATTEST(capital_attrs, wrapped_instrument, sf_table_version)
RETURN capital_attrs
```

By way of non-limiting numerical illustration only, and solely for the purpose of illustrating the computation mechanics without limiting the scope of the claims, consider a wrapped binary event contract derived from a native prediction market contract with the following parameters: notional $1,000,000; residual maturity 0.75 years (9 months); current market value $15,000; no collateral posted; asset classification of “other” under the committed supervisory factor table with supervisory factor sf=0.18; alpha multiplier α=1.4 per SA-CCR; no netting set applicable; and no VPCS-derived risk adjustment. The capital treatment mapping module computes: replacement cost RC=max ($15,000−$0, 0)=$15,000; maturity factor MF=min(1.0, √(min(0.75, 1.0)/1.0))=√0.75≈0.866; asset-class add-on=$1,000,000·0.18·0.866≈$155,880; aggregate add-on (no netting)=$155,880; potential future exposure PFE=$155,880·1.0=$155,880; exposure at default EAD=1.4·($15,000+$155,880)≈$239,232. All committed methodology parameters (supervisory factor table version, alpha value, maturity factor formula identifier, asset-class classification, netting determination) are included in the compliance attestation record, enabling the consuming institution to independently verify the capital treatment computation against the committed parameters. The foregoing numerical values are illustrative of the computation mechanics; the specific choice of supervisory factor and asset-class classification for event contracts is illustrative only and depends on final regulatory classification under applicable Basel implementation rules and U.S. federal banking agency guidance, which specific classification is not necessary to practice the invention and does not limit the scope of the claims. By way of further non-limiting illustration of the designated fallback disposition of paragraph [0028a], a committed conservative default supervisory factor in an illustrative range of approximately 0.20 to 0.30 may be applied for unclassified event contracts pending a formal supervisory determination; this range is illustrative only, is not asserted to reflect any actual or anticipated supervisory determination, and the specific value applied in any embodiment is a committed parameter of the capital mapping methodology configurable by the party or parties responsible for its configuration.

In a further embodiment, the capital treatment mapping module applies netting aggregation within a qualified netting set under applicable Basel rules, producing a netting-set-level potential future exposure that may be lower than the sum of per-instrument add-ons where offsetting positions exist. In another embodiment, the module computes separate capital attributes under multiple prudential frameworks—for example, Basel III finalized-reforms SA-CCR, SEC net-capital haircut methodology, and CFTC segregation requirements—and includes each attribute set in the compliance attestation record for consumption by institutions operating under multiple prudential regimes.

### F. Regulatory Reporting Transformation

The reporting transformation module, executing within the hardware trusted execution environment, automatically maps wrapped instrument definitions and associated position records to regulatory reporting records under a committed reporting schema mapping. The committed reporting schema mapping is a versioned, sealed artifact identifying, for each combination of wrapped-instrument treatment attributes and position-size thresholds, the applicable reporting schema and delivery endpoint. In one non-limiting embodiment, the committed reporting schema mapping produces: 17 C.F.R. Part 16 trade and volume records for wrapped instruments whose treatment attributes classify them as contracts traded on a Designated Contract Market; 17 C.F.R. Part 17 large-trader records for positions exceeding applicable thresholds; 17 C.F.R. Part 45 swap data records for wrapped instruments whose treatment attributes classify them as swaps under the committed jurisdictional rule set, delivered to CFTC-registered Swap Data Repositories; and, where the wrapped instrument definition classifies the underlying contract as a security or security-based swap subject to Consolidated Audit Trail reporting requirements under Rule 613 of Regulation NMS (17 C.F.R. § 242.613), Consolidated Audit Trail records (it being noted that the Consolidated Audit Trail does not generally apply to CFTC-regulated event contracts). The module does not produce swap data reporting records for wrapped instruments whose treatment attributes do not classify them as swaps. The module supports ISO 20022 compliant messaging schemas, FIX protocol extensions for derivatives reporting, Bloomberg Data License delivery formats, and Refinitiv DataScope delivery formats. Each reporting record is accompanied by a hardware-attestation quote binding the reporting record to the compliance attestation record, to the committed reporting schema mapping version, and to the underlying wrapped instrument definition.

Field-level transformation from a wrapped instrument record to a reporting record under a given reporting schema proceeds through the committed reporting schema mapping by an attested schema-transformation procedure. For each reporting-record field, the committed reporting schema mapping identifies (i) the source field or fields in the wrapped instrument record from which the reporting-record field is derived, (ii) the transformation function applied (identity, type cast, enumeration remapping, unit conversion, derivation formula), (iii) any committed constants or parameters consumed by the transformation function, and (iv) a validity predicate applied to the transformed value. The transformation procedure enforces the validity predicate within the hardware trusted execution environment before emission of the reporting record; failures produce a REPORTING_SCHEMA_MISMATCH exception per paragraph

For conditional fields—fields required only when certain treatment attributes apply—the committed reporting schema mapping identifies the enabling predicate over wrapped-instrument fields. For each produced reporting record, the module emits a companion schema-transformation log comprising, for each field, the source-field identifier, the transformation function identifier, and a cryptographic hash of the transformed value; the schema-transformation log is committed to the compliance attestation record, enabling a relying party to independently reproduce the transformation from the wrapped instrument record and verify consistency with the delivered reporting record.

### G. Compliance Attestation and Export Interface

The attestation module, executing within the hardware trusted execution environment, produces compliance attestation records on an event-driven basis following each production of a wrapped instrument definition and capital treatment assignment. Each compliance attestation record binds together, at minimum: (i) the measurement value of the compliance code base as measured by hardware; (ii) a hardware-vendor-signed chain-of-trust certificate bound to the hardware identity of the hardware trusted execution environment; (iii) a cryptographic commitment over the ingested native contract specifications, position records, and participant-identity records; (iv) a cryptographic commitment over the committed rule sets in force during the computation, including at least the KYC/AML rule set version, the jurisdictional rule set version, the supervisory factor table version, the capital methodology parameters, and the reporting schema version; (v) the wrapped instrument definition attributes, the assigned capital treatment attributes, and the generated regulatory reporting records; and (vi) a signature over the foregoing fields produced using the hardware-rooted attestation key. The compliance attestation record is produced in a format verifiable against the hardware vendor's attestation service as described in the HATIS and VPCS companion applications.

The institutional export interface delivers the wrapped instrument definition, capital treatment attributes, regulatory reporting records, compliance attestation record, and methodology disclosure record in formats accepted by institutional balance-sheet systems and regulatory endpoints. Exports may additionally include a zero-knowledge proof attesting that the wrapped instrument was produced according to the committed compliance rules on participant records consistent with an external commitment, without disclosing participant-level data to the recipient, in compliance with applicable privacy law including without limitation the California Consumer Privacy Act and equivalent foreign statutes. The tamper-evident methodology ledger maintains, external to the trusted execution environment but receiving only hardware-signed writes therefrom, an append-only record of compliance attestation records and wrapped instrument definitions organized as leaves of a Merkle accumulator whose root is periodically committed to an external public commitment channel.

### H. Privacy-Preserving and Multi-Party Extensions

Further embodiments incorporate privacy-preserving and multi-party-computation primitives. In one embodiment, differential-privacy noise calibrated to a configured privacy budget is applied to aggregate compliance outputs before export to aggregate data consumers, with the noise parameters themselves committed to the attestation record; this arrangement provides mathematical privacy guarantees with respect to individual participant positions while preserving the informational utility of the aggregate outputs. In another embodiment, cross-institution compliance processing is performed using secure multi-party computation with hardware-TEE-anchored participants, such that no single institutional counterparty observes the complete compliance record of positions held by another institutional counterparty. In a further embodiment, participant-identity records are processed using pseudonymous identifiers derived from cryptographic hashes of know-your-customer attestation data, such that the compliance computation can identify the same participant across multiple wrapped instruments without retaining personally identifiable information in plaintext at any point, satisfying data minimization requirements under applicable privacy law.

### I. Computer System Environment

The invention may be practiced on any computer hardware providing the TEE properties described in paragraph [0019f]. Non-limiting example configurations include single-tenant bare-metal servers with TEE-equipped processors, confidential-compute virtual machines offered by cloud infrastructure providers such as those supporting Intel SGX, Intel TDX, or AMD SEV-SNP, and hybrid deployments combining on-premises TEE-equipped servers for latency-sensitive compliance processing with cloud-hosted attestation-verification services. Sealed rule-set storage is implemented on any persistent storage medium accessible within the trusted execution environment through encrypted channels, subject to sealing and update-attestation protocols. Key management for the attestation module and for any export-layer signatures is anchored in hardware security modules operating in accordance with Federal Information Processing Standard-3 Level 3 or equivalent certification.

Rule-set version control is anchored to the hardware identity of the hardware trusted execution environment through the sealing mechanism. Each committed rule set and committed methodology—the committed KYC/AML rule set, the committed jurisdictional rule set, the committed capital mapping methodology, the committed supervisory factor table, and the committed reporting schema mapping—is stored in an encrypted sealed store keyed to the hardware identity of the hardware trusted execution environment and to a committed authorized-measurement set; the sealed store is readable only by compliance code whose hardware measurement register value is present in the authorized-measurement set. Rule-set updates are delivered to the hardware trusted execution environment through an attested governance channel: a proposed update is signed by an authorized update key whose certificate chains to a governance root certificate committed at system initialization, wrapped in an update record comprising (i) the updating authority's identity, (ii) the update timestamp, (iii) the prior committed-version identifier, (iv) the new committed-version identifier, (v) a cryptographic commitment over the new rule-set contents, and (vi) the authorized update signature. Upon receipt within the hardware trusted execution environment, the update record is verified against the committed governance root, the new rule set is sealed under the new committed-version identifier, and an attested update-acknowledgment record is produced and committed to the tamper-evident methodology ledger. Rollback to a prior committed-version identifier is supported through a rollback record analogously signed by an authorized rollback key and attested to the ledger, enabling remediation of defective updates with a full audit trail of the update-rollback history. The committed-version identifier of each rule set and methodology in force during any compliance computation is bound to the compliance attestation record for that computation through the cryptographic commitment of paragraph [0031] (iv), such that any relying party verifying a historical compliance attestation record can deterministically identify the rule-set and methodology versions applied. This arrangement supports auditable rule-set governance without compromising the cryptographic integrity of historical compliance attestation records produced under prior rule-set versions. As a secondary, optional embodiment not central to the present invention, the hardware-rooted attestation key and the signatures produced therewith may alternatively be generated using a post-quantum digital signature algorithm in place of or in addition to a classical signature algorithm, such that compliance attestation records remain independently verifiable against the hardware-vendor attestation service in a post-quantum threat environment; the choice of signature algorithm is a design parameter of the underlying hardware trusted execution environment and attestation infrastructure and does not alter the core hardware-attestation architecture of the present invention.

### J. Best Mode

The inventor contemplates the following as the best mode of practicing the invention at the time of filing. The preferred embodiment operates as the third element of an integrated three-system hardware-attested infrastructure stack for regulated prediction market exchanges, comprising the HATIS companion application for trade integrity surveillance, the VPCS companion application for signal-weighted probability extraction, and the present invention for institutional compliance bridging, with the three systems sharing a common root of trust through federated hardware attestation as described in Section O. The preferred embodiment comprises: a hardware trusted execution environment implemented on Intel Trust Domain Extensions hardware with an AMD SEV-SNP fallback configuration for cross-vendor deployment; rule-engine-based jurisdictional mapping with committed rule-set versions sealed to the TEE hardware identity and updated through attested governance channels as described in paragraph [0034a]; SA-CCR-based committed capital mapping methodology with a committed supervisory factor table version aligned to the applicable U.S. federal banking agency implementation rules; integration with the HATIS and VPCS companion applications through the companion-integration interface, such that surveillance findings from HATIS and signal-weighted probability outputs from VPCS are consumed as inputs to the KYC/AML screening module and the capital treatment mapping module respectively; compliance attestation records formatted for direct submission to CFTC-registered Swap Data Repositories under Part 45 for wrapped instruments classified as swaps and, for wrapped instruments classified as securities or security-based swaps subject to Consolidated Audit Trail reporting requirements under applicable SEC rules, for Consolidated Audit Trail delivery; institutional export records formatted for Bloomberg Data License and Refinitiv DataScope delivery with ISO 20022 compliant metadata; and commitment of compliance attestation records to a Merkle-accumulator tamper-evident ledger whose root is published to a public blockchain and, in embodiments where a regulator-operated or consortium-operated commitment endpoint becomes available, additionally mirrored to such endpoint or channel as a non-limiting, prospective alternative or supplement. All referenced technologies are identified as the best mode as of the filing date and are not admitted to constitute prior art against the claims presented herein.

### K. Alternative Embodiments

The embodiments described above are illustrative and are not intended to limit the scope of the invention. Alternative embodiments include, without limitation: machine-learning-assisted KYC/AML screening using classifiers trained on labeled enforcement histories in place of or in addition to rule-based screening; dynamic rule-set updates delivered through attested governance channels whose update authority is itself hardware-attested; leverage-adjusted and margin-sensitive capital mappings for wrapped instruments traded on margin; extensions to foreign regulatory schemas including EU MiFID II and EMIR, UK FCA, Japan FSA, Singapore MAS, and other major foreign regimes; application to event-linked derivatives outside the prediction market context, including but not limited to parametric insurance contracts, weather derivatives, and event-contingent swaps traded on registered swap execution facilities; and extension of the integrated HATIS/VPCS/RCW three-system architecture described in Section O to additional compliance subsystems addressing market abuse, best execution, and transaction cost analysis. Features from different embodiments may be combined. Numerical thresholds and specific algorithms are exemplary; the full scope extends to equivalents.

### L. Technical Problem Solved and Computer-Functional Improvement

The invention solves a specific technical problem that arises only in computer-implemented compliance processing for prediction market contracts and has no analog in pre-computer derivatives markets. A prudentially regulated institutional counterparty—a bank, broker-dealer, asset manager, central bank, sovereign wealth fund, pension fund, or equivalent regulated entity subject to Basel capital frameworks, CFTC reporting obligations, SEC net capital rules, or equivalent foreign prudential supervision—cannot acquire, hold, intermediate, or report a prediction market position with cryptographic assurance that the applied KYC/AML screening methodology, jurisdictional treatment mapping, capital methodology, and regulatory reporting records have not been altered by the exchange operator or by any other party. Software-only compliance overlays operating on exchange-operator-controlled infrastructure cannot provide this assurance because the exchange operator retains the technical capability to modify any software-produced compliance record prior to disclosure. Institutional counterparties subject to model risk management frameworks—including the U.S. federal banking agencies' SR 11-7 supervisory guidance, the Basel Committee principles on model risk management, and OECD prudential supervision principles—cannot document the integrity of compliance processing applied to their own balance-sheet positions using software-attested records alone.

The invention addresses this problem through the specific combination of (a) isolation of compliance processing within a hardware trusted execution environment having a hardware measurement register and a hardware-rooted attestation key, (b) hardware-anchored cryptographic measurement of the compliance code base upon instantiation, (c) hardware-sealed storage of committed rule sets and methodology parameters, (d) hardware-anchored cryptographic binding of each compliance output to the code-base measurement and to cryptographic commitments over the committed rule sets in force, and (e) production of compliance attestation records verifiable by any relying party against a hardware-vendor attestation service without participation of the exchange operator. The technical effect—cryptographic third-party verifiability of compliance output integrity—is unobtainable by software-only compliance systems regardless of the care with which such systems are audited. This effect directly enables downstream uses: balance-sheet holding of wrapped positions with attested SA-CCR documentation supporting Basel supervisory documentation and review requirements; Swap Data Repository ingestion with attestation quotes binding reports to rule-set versions supporting Part 45 audit obligations; institutional counterparty diligence without operator reliance; and supervisory verification against the hardware-vendor attestation service without reliance on representations of the exchange operator or the counterparty's own compliance staff.

The following is a non-limiting, illustrative example, in JSON-like notation, of a wrapped instrument definition produced by one embodiment for a single binary event contract:

{ “contract_id”: “EVT-2026-004471”, “native_venue”: “example-DCM”,
“regulatory_designation”: “CEA_DCM_CONTRACT”, “notional”: 10000, “settlement_type”:
“cash”, “maturity”: “2026-11-03”, “clearinghouse”: “example-DCO”,
“jurisdictional_rule_set_version”: “us-cea-v14”, “decision_tree_path”: { “terminal_rule_id”:
“RULE-CEA-014”, “priority_rank”: 2 }, “capital_treatment”: { “replacement_cost”: 0,
“potential_future_exposure”: 340.12, “exposure_at_default”: 476.17,
“supervisory_factor_table_version”: “saccr-2025q4“ }, “reporting_schema_version”: “part16-
v3”, “reporting_transformation_log_id”: “RTL-2026-004471” }

The following is a non-limiting, illustrative example, in JSON-like notation, of a compliance attestation record produced by one embodiment for the wrapped instrument definition of paragraph [0038a]:

{ “measurement_register”: “0x7ac3...”, “chain_of_trust_cert”: “vendor-cert-4471”,
“native_contract_hash”: “0x9be1...”, “position_record_hash”: “0x2fa0...”,
“participant_identity_commitment”: “0x51dd...”, “rule_set_hash”: “0x88c2...”,
“decision_tree_path”: { “terminal_rule_id”: “RULE-CEA-014”, “priority_rank”: 2 },
“wrapped_output_hash”: “0x0e77...”, “reporting_output_hash”: “0xa412...”, “nonce”: “0x5f3d...”,
“timestamp”: “2026-11-03T14:22:07Z”, “signature”: “0x1abf...” }

### M. Exemplary Institutional Use Case: Central Bank, Sovereign, and G-SIB Trading Desk

By way of non-limiting, illustrative and hypothetical example of downstream institutional uses that could be enabled by the technical effect described in Section L, should such institutions elect to adopt the present invention, a central bank treasury operations desk, a sovereign wealth fund portfolio management system, a systemically important bank (G-SIB) trading desk subject to Basel III finalized-reforms capital requirements and home-country comprehensive capital analysis (e.g., U.S. CCAR or equivalent foreign supervisory review), a broker-dealer subject to SEC net capital rules under Exchange Act Rule 15c3-1, an insurance company regulated by state insurance departments with statutory capital requirements, or a pension fund regulated by the Pension Benefit Guaranty Corporation or equivalent foreign pension supervisor, may acquire, hold, intermediate, or report wrapped prediction market instruments produced by the system of the present invention with cryptographic documentation of the applied compliance processing sufficient to support the institution's model risk management and supervisory documentation processes. For example, a G-SIB trading desk may hold a wrapped prediction market instrument on its trading book with SA-CCR capital treatment assigned by the capital treatment mapping module; for example, attested documentation of a qualified netting set may enable the G-SIB to apply netting benefits to its potential future exposure calculation with greater confidence than would be available absent independently verifiable documentation of the applied netting determination, a hypothetical benefit whose magnitude depends on the specific netting set composition and is not quantified herein, such that the supervisory documentation maintained by the G-SIB for internal capital adequacy assessment process (ICAAP) and CCAR purposes includes the compliance attestation record produced by the present invention as independent documentation of the applied capital methodology, the committed supervisory factor, the committed netting determination, and the applied rule-set versions. The G-SIB's supervisor—the Federal Reserve Board or equivalent home-country supervisor—may independently verify the integrity of this documentation against the hardware-vendor attestation service without relying on representations of the prediction market exchange operator or of the G-SIB's own compliance staff. A central bank may incorporate wrapped prediction market instrument positions into financial stability assessments, monetary policy preparation materials, and reserve management operations with supervisory documentation that meets the central bank's internal model validation standards. A sovereign wealth fund may record wrapped positions in its portfolio management system with capital attribution documented in attested records acceptable to the fund's sovereign oversight bodies. Equivalent use cases arise for asset managers subject to the Investment Advisers Act, registered investment companies under the Investment Company Act of 1940, and cross-border counterparties subject to ESMA, FCA, PRA, MAS, or BaFin prudential supervision.

### N. Non-Obviousness of the Claimed Combination Over Individual Component Fields

The combination of elements claimed herein is non-obvious under the KSR v. Teleflex framework and the Graham v. John Deere factors notwithstanding that individual components—hardware trusted execution environments, rule-based compliance processing engines, Basel capital calculation engines, and regulatory reporting transformers—are individually known. Each contributing field teaches toward its own objectives and away from the specific combination of the present invention. Derivatives compliance platforms assume software-based processing on operator-controlled infrastructure with software-audit-based verification; hardware-TEE architectures exemplified by Intel SGX, Intel TDX, AMD SEV-SNP, and ARM CCA were developed for confidentiality of private inputs in confidential-computing use cases, not for third-party verifiability of public compliance outputs; Basel capital frameworks exemplified by Basel Committee Publication 279 assume the reporting institution performs and documents its own capital computation under its home-country supervisor's audit regime; and CFTC and SEC regulatory reporting literature assumes operator-certified software-based report generation. None of the foregoing fields individually, nor any obvious combination of them, would motivate a skilled artisan to assemble the claimed combination of TEE isolation, hardware attestation, sealed rule-set storage, and integrated compliance processing for prediction markets.

The non-obviousness is further supported by a specific architectural distinction. Existing institutional compliance platforms were designed under operating assumptions predicated on an ecosystem of trusted counterparties-established exchanges, clearinghouses, and custodians accorded institutional trust at the level sufficient for software-audit-based verification. The prediction-markets-as-regulated-infrastructure context inverts this assumption: the prediction market operator is a newly regulated entity without established institutional trust at the software-audit level, as evidenced by the emergence of QCX LLC (operating as Polymarket US) as an intermediated DCM under the Nov. 24, 2025 Amended Order of Designation (announced Nov. 25, 2025) and by the CFTC Division of Enforcement and Division of Market Oversight regulatory actions of February 25 and Mar. 12, 2026. The claimed combination addresses this contextual inversion by relocating the basis of trust from the exchange operator's representations to the hardware vendor's attestation service, verifiable by relying parties without operator participation. This relocation is not taught, suggested, or motivated by any combination of prior-art platforms designed for the traditional trusted-operator context, and produces a synergistic technical effect-cryptographic third-party verifiability of compliance processing integrity in a low-trust-operator context-that is materially greater than and qualitatively distinct from the sum of the separately-known effects of the individual components.

### O. Integration with Companion Hardware-Attested Systems

In further embodiments, the regulatory-compliant wrapper system of the present invention operates in technical integration with two companion hardware-attested systems. Each integration is defined by a specific data flow across a hardware-attestation boundary and produces a measurable functional effect on the compliance outputs produced by the present invention. The integrations described in this Section O are independent of one another and may be present individually or jointly.

HATIS integration. The companion Hardware-Attested Trade Integrity System (HATIS) produces, for each participant account observed at the prediction market exchange, a trade-integrity record comprising (i) an account-linkage fingerprint vector in a real-valued feature space of dimension n, representing measured similarities to other accounts across trade-timing, counterparty, and behavioral features, (ii) a cross-account coordination score in the interval [0, 1], representing the likelihood of coordinated trading across accounts, and (iii) a HATIS attestation quote identifier cryptographically binding the trade-integrity record to the HATIS hardware measurement register value. The KYC/AML screening module of the present invention receives, through the companion-integration interface, the HATIS trade-integrity record for each participant referenced in a position record. The module verifies the HATIS attestation quote against the hardware-vendor attestation service and, upon successful verification, adds a contribution of the form β_linkage·∥linkage_fingerprint∥+γ_coordination. coordination_score to the composite risk score computed in paragraph [0024], where β_linkage and γ_coordination are committed rule-set parameters in the committed KYC/AML rule set, and where ∥⋅∥ denotes a committed norm function identified in the rule set. Upon failed verification of the HATIS attestation quote, the module emits a COMPANION_SYSTEM_ATTESTATION_FAILURE exception per paragraph [0027b]. The HATIS attestation quote identifier is committed to the compliance attestation record of the present invention. Measurable functional effect: the composite risk score is modified by a bounded quantity that is a deterministic function of verified HATIS outputs and committed rule-set parameters, and a relying party can reproduce this modification from the delivered inputs and verify consistency with the delivered composite risk score.

VPCS integration. The companion Verified Prediction Confidence Scoring Engine (VPCS) produces, for each prediction market contract at a query time, a probability record comprising (i) a signal-weighted probability in [0, 1], (ii) a calibrated probability in [0, 1] accompanied by a frequentist confidence interval at a committed coverage level, (iii) a scalar insider-risk indicator in [0, 1] computed at a configured z-score threshold, and (iv) a VPCS attestation quote identifier cryptographically binding the probability record to the VPCS hardware measurement register value. The capital treatment mapping module of the present invention receives, through the companion-integration interface, the VPCS probability record for each wrapped instrument referencing the corresponding prediction market contract. The module verifies the VPCS attestation quote against the hardware-vendor attestation service and, upon successful verification, applies a risk adjustment of the form EAD_adjusted=EAD·(1+δ·insider_risk_indicator), where EAD is the exposure at default computed under the committed capital mapping methodology per paragraph [0028], δ is a committed rule-set parameter in the committed capital mapping methodology, and the adjustment is bounded by a committed cap in the rule set. Upon failed verification of the VPCS attestation quote, the module emits a COMPANION_SYSTEM_ATTESTATION_FAILURE exception per paragraph [0027b]. The VPCS attestation quote identifier is committed to the compliance attestation record of the present invention. Measurable functional effect: the exposure-at-default attribute delivered to the consuming institution is a deterministic function of the computed EAD, the verified VPCS insider-risk indicator, and the committed parameter δ, and a relying party can reproduce the adjustment from the delivered inputs and verify consistency with the delivered EAD_adjusted value.

Federated attestation root. The three hardware-anchored systems—HATIS, VPCS, and the present invention—may operate within a single hardware trusted execution environment on a common hardware platform, or within separate hardware trusted execution environments on distinct hardware platforms whose hardware-vendor attestation quotes chain to a common vendor root certificate. In the federated deployment, each compliance attestation record of the present invention includes, in addition to the fields enumerated in paragraph [0031], (i) the HATIS attestation quote identifier of each HATIS attestation quote consumed during the computation interval and (ii) the VPCS attestation quote identifier of each VPCS attestation quote consumed during the computation interval. A composite verification procedure executable by a relying party comprises: (1) verifying the hardware-vendor attestation quote of the present invention's compliance attestation record against the hardware-vendor attestation service; (2) resolving the HATIS and VPCS attestation quote identifiers committed in the compliance attestation record to their respective attestation quotes; (3) verifying each resolved HATIS and VPCS attestation quote against the hardware-vendor attestation service; (4) confirming that the hardware-vendor root certificate of each verified quote matches a common vendor root in an authorized-vendor set configured by the relying party; and (5) confirming that the cryptographic commitments in the compliance attestation record are consistent with the inputs represented in the HATIS and VPCS attestation records. Successful completion of the composite verification procedure confirms, without participation of or reliance on representations by the prediction market exchange operator or the three-system operator, that the compliance attestation record was produced under committed rule sets from inputs whose trade-integrity basis and probability-characterization basis are each independently hardware-attested and verifiable. This three-system composite verification produces a cryptographic chain of custody across trade execution, probability characterization, and compliance wrapping that cannot be reproduced by any of the three systems operating alone or by any combination of software-only components, and the claimed combination therefore supports documentation and supervisory review in connection with DCM Core Principle 3 (contracts not readily susceptible to manipulation), Core Principle 4 (market monitoring), Core Principle 12 (market participant protection), CFTC Rule 180.1 (fraud and manipulation), and applicable Basel capital framework obligations through a unified and independently verifiable cryptographic pathway.

What is claimed is:

1. A regulatory-compliant wrapper system for producing a wrapped instrument definition documenting institutionally consumable compliance treatment of a native prediction market contract, comprising:
(a) at least one compliance processing engine, executing within a hardware trusted execution environment having a hardware measurement register and a hardware-rooted attestation key provisioned by a hardware vendor, the hardware trusted execution environment configured to load a measured compliance code base such that the contents of the hardware measurement register cryptographically bind to the loaded code base upon instantiation, the compliance processing engine comprising the modules recited in subparts (c) through (g);
(b) a native data intake interface configured to deliver native prediction market contract specifications, associated position records, and participant-identity records into the hardware trusted execution environment over encrypted channels terminating at endpoints within the hardware trusted execution environment, wherein the participant-identity records delivered into the hardware trusted execution environment comprise plaintext know-your-customer attestation data sufficient to perform the screening of subpart (c), and wherein participant-identity records referenced in the compliance attestation record and in any record exported from the hardware trusted execution environment comprise pseudonymized identifiers derived from cryptographic hashes of the plaintext know-your-customer attestation data, such that plaintext of said records is not exposed outside the hardware trusted execution environment within the wrapper operator's environment during a computation interval;
(c) a know-your-customer and anti-money-laundering screening module executing within the hardware trusted execution environment and configured to apply automated screening against a committed rule set sealed to the hardware identity of the hardware trusted execution environment, using the participant-identity records, sanctions and watchlist data, and optional linkage fingerprints received from a companion hardware-attested trade integrity system, producing a screened record with a composite risk score, a disposition indicator, and a rule-set version identifier;
(d) a jurisdictional mapping module executing within the hardware trusted execution environment and configured to enforce eligibility and structuring rules by jurisdiction in accordance with a jurisdictional rule set sealed to the hardware identity of the hardware trusted execution environment and to transform the native prediction market contract into a wrapped instrument definition with institution-specific treatment attributes assigned under the jurisdictional rule set, wherein the treatment attributes identify the regulatory designation applicable to the contract under the Commodity Exchange Act, the Securities Exchange Act of 1934, or an equivalent foreign regulatory regime as determined by the jurisdictional rule set in force during the computation;
(e) a capital treatment mapping module executing within the hardware trusted execution environment and configured to assign institution-specific capital treatment attributes to the wrapped instrument definition under a capital mapping methodology, wherein in one embodiment the capital mapping methodology comprises a replacement cost component, a potential future exposure component computed under the Standardized Approach for Counterparty Credit Risk using a committed supervisory factor table and a committed alpha multiplier, and an exposure at default value, with netting applied under a committed netting determination identified in the capital mapping methodology;
(f) a reporting transformation module executing within the hardware trusted execution environment and configured to generate regulatory reporting records from the wrapped instrument definition under a committed reporting schema mapping, wherein in one embodiment the committed reporting schema mapping produces (i) records compliant with 17 C.F.R. Part 16 for wrapped instruments whose treatment attributes classify them as contracts traded on a Designated Contract Market, (ii) records compliant with 17 C.F.R. Part 17 for wrapped instruments whose position size exceeds applicable large-trader thresholds identified in the committed reporting schema mapping, (iii) records compliant with 17 C.F.R. Part 45 for wrapped instruments whose treatment attributes classify them as swaps under the jurisdictional rule set, and (iv) records compliant with equivalent foreign regulatory schemas for wrapped instruments whose treatment attributes classify them under equivalent foreign regulatory regimes; and
(g) an attestation module configured to produce a compliance attestation record cryptographically signed by the hardware-rooted attestation key and binding together (i) the contents of the hardware measurement register, (ii) a cryptographic commitment over the ingested native contract specifications, position records, and participant-identity records, (iii) a cryptographic commitment over the committed rule sets and methodology parameters in force during the computation, including at least the KYC/AML rule-set version, the jurisdictional rule-set version, the supervisory factor table version, the alpha multiplier, and the reporting schema version, and (iv) the wrapped instrument definition attributes, the assigned capital treatment attributes, and the generated regulatory reporting records, wherein said compliance attestation record is independently verifiable by a regulator or institutional counterparty against a hardware-vendor attestation service without participation of, or reliance on representations by, an operator of the prediction market exchange, and wherein the claimed combination of (I) the hardware-sealed storage of the committed rule sets recited in subparts (c) through (f), (II) the binding of the hardware measurement register to the compliance code base upon instantiation, and (III) the signature of the compliance attestation record by the hardware-rooted attestation key, together produce compliance outputs whose rule-set integrity, input-record integrity, and methodological integrity are cryptographically verifiable by a third party against the hardware-vendor attestation service, a verification pathway structurally unavailable to a software-only compliance process executing on a generic computer lacking a hardware measurement register and hardware-rooted attestation key.

2. The system of claim 1, wherein the hardware trusted execution environment comprises at least one of Intel Software Guard Extensions, Intel Trust Domain Extensions, AMD Secure Encrypted Virtualization with Secure Nested Paging, ARM Confidential Compute Architecture, or any equivalent or successor confidential computing architecture providing hardware-rooted measurement, isolation, and remote attestation, and wherein the hardware-rooted attestation key and hardware measurement register are provided by said hardware trusted execution environment.

3. The system of claim 1, wherein the compliance processing engine integrates (i) surveillance findings from a companion Hardware-Attested Trade Integrity System including account-linkage fingerprints, anomalous-trade indicators, and cross-account coordination signals, and (ii) signal-weighted probability outputs from a companion Verified Prediction Confidence Scoring Engine including calibrated probability estimates, confidence intervals, and insider-risk indicators computed at a configured z-score threshold, wherein the know-your-customer and anti-money-laundering screening module incorporates the surveillance findings into the composite risk score and the capital treatment mapping module incorporates the signal-weighted probability outputs as risk adjustments to the potential future exposure calculations, and wherein identities of the companion systems and their attestation quote references are committed to the compliance attestation record.

4. The system of claim 1, wherein the jurisdictional mapping module maintains a plurality of jurisdiction-specific rule sets for at least U.S. CEA-designated contract markets under Commodity Exchange Act Section 5, U.S. intermediated CEA-designated contract markets permitting futures-commission-merchant intermediation, U.S. SEC-registered securities exchanges under the Securities Exchange Act of 1934, and equivalent foreign regulatory regimes, each rule set comprising eligibility determinations, permitted contract-type classifications, structuring parameters, and reporting-schema identifiers, and wherein the wrapped instrument definition produced by the transformation includes attributes necessary for institutional balance-sheet recognition, margining, clearinghouse intermediation, and supervisory documentation, and wherein the jurisdictional mapping module determines the wrapped instrument definition using a committed decision tree such that, where more than one terminal rule of the decision tree applies to the native prediction market contract, a deterministic precedence order by priority rank resolves the applicable terminal rule, and a terminal rule identifier and priority rank of the applied terminal rule are committed to the compliance attestation record.

5. The system of claim 1, wherein the capital mapping methodology applied by the capital treatment mapping module computes, for each wrapped instrument definition, (i) the replacement cost as the maximum of zero and the current market value reduced by applicable collateral, (ii) an asset-class add-on as the product of a committed supervisory factor, an effective notional amount, and a committed maturity factor, (iii) a potential future exposure as the aggregate asset-class add-on adjusted by a committed netting multiplier, and (iv) an exposure at default value as the committed alpha multiplier applied to the sum of the replacement cost and the potential future exposure, and wherein the capital treatment attributes are output together with cryptographic commitments to the capital mapping methodology version, the committed supervisory factor table version, and the committed alpha multiplier, and wherein, for a native prediction market contract of an asset class for which no supervisory factor has been formally settled by the applicable prudential regulator, the capital treatment mapping module applies a designated fallback disposition identified in the capital mapping methodology, the designated fallback disposition comprising at least one of an exception record produced in lieu of a wrapped instrument capital attribute set, application of a committed conservative default supervisory factor pending a formal supervisory determination, or a manual-review flag requesting institution-side or supervisor-side override, the applied designated fallback disposition and its basis being committed to the compliance attestation record.

6. The system of claim 1, further comprising a position-limit enforcement module executing within the hardware trusted execution environment and configured to apply automated hard blocks or soft flags to wrapped instrument records based on concentration thresholds derived from attested data received from the companion systems, and a differential-privacy module configured to apply calibrated noise to aggregate compliance outputs before export with noise parameters committed to the compliance attestation record, such that individual participant positions are not disclosed to aggregate data consumers while preserving the statistical utility of aggregate compliance reporting, in compliance with applicable privacy law including without limitation the California Consumer Privacy Act and equivalent foreign statutes, and wherein the pseudonymized identifiers derived by the KYC/AML screening module are derived using SHA-256 or an equivalent or successor collision-resistant hash function identified by the committed rule set, the identifier of the applied hash function being committed to the compliance attestation record.

7. The system of claim 1, further comprising a tamper-evident methodology ledger configured to receive, under control of the hardware trusted execution environment, append-only records comprising compliance attestation records and associated wrapped instrument definitions, and to organize said records as leaves of a Merkle accumulator whose root is periodically committed to an external public commitment channel comprising at least one of a public blockchain, a regulator-operated commitment endpoint, and a consortium-operated commitment channel, wherein a relying party is enabled to verify the temporal integrity of a past compliance attestation record by obtaining a Merkle inclusion proof from the ledger, verifying said inclusion proof against a published Merkle accumulator root, and verifying the compliance attestation record against the hardware-vendor attestation service, wherein each compliance attestation record comprises, in a format verifiable against the hardware-vendor attestation service: a hardware measurement register value bound to the compliance code base; a hardware-vendor-signed chain-of-trust certificate; a cryptographic hash of the native contract specifications, a cryptographic hash of the position records, and a cryptographic commitment over the participant-identity records; a cryptographic commitment over the committed rule sets and methodologies in force; a terminal rule identifier and priority rank of a jurisdictional decision tree applied during the computation; a cryptographic hash of the wrapped instrument definition attributes and assigned capital treatment attributes; a cryptographic hash of the regulatory reporting records; and a schema-transformation log identifying, for each field of the regulatory reporting records, a source field, a transformation function identifier, and a cryptographic hash of the transformed value; a nonce and a timestamp, each bound to the other fields; and a signature over the foregoing fields produced using the hardware-rooted attestation key, thereby supporting documentation and supervisory review in connection with DCM Core Principle 4 and Core Principle 12.

8. A method of producing a wrapped instrument definition documenting regulatory-compliance treatment of a prediction market contract, the method comprising:
loading a measured compliance code base into a hardware trusted execution environment having a hardware measurement register and a hardware-rooted attestation key, such that the contents of the hardware measurement register cryptographically bind to the loaded code base upon instantiation;
ingesting, into the hardware trusted execution environment over encrypted channels terminating at endpoints within the hardware trusted execution environment, native prediction market contract specifications, associated position records, and participant-identity records, wherein the participant-identity records ingested into the hardware trusted execution environment comprise plaintext know-your-customer attestation data sufficient to perform the applying step below, and wherein participant-identity records referenced in the compliance attestation record and in any record exported from the hardware trusted execution environment comprise pseudonymized identifiers derived from cryptographic hashes of the plaintext know-your-customer attestation data, such that plaintext of said records is not exposed outside the hardware trusted execution environment within the wrapper operator's environment during a computation interval;
applying, within the hardware trusted execution environment, know-your-customer, anti-money-laundering, sanctions, and eligibility screening against a committed rule set sealed to the hardware identity of the hardware trusted execution environment, producing a screened record with a composite risk score and a disposition indicator;
mapping, within the hardware trusted execution environment, the native prediction market contract to a wrapped instrument definition with institution-specific treatment attributes assigned under a jurisdictional rule set, wherein the treatment attributes identify the regulatory designation applicable to the contract under the Commodity Exchange Act, the Securities Exchange Act of 1934, or an equivalent foreign regulatory regime as determined by the jurisdictional rule set in force during the computation;
assigning, within the hardware trusted execution environment, institution-specific capital treatment attributes to the wrapped instrument definition under a capital mapping methodology, wherein in one embodiment the capital mapping methodology comprises a replacement cost component, a potential future exposure component computed under the Standardized Approach for Counterparty Credit Risk using a committed supervisory factor table and a committed alpha multiplier, and an exposure at default value, with netting applied under a committed netting determination;
generating, within the hardware trusted execution environment, regulatory reporting records from the wrapped instrument definition under a committed reporting schema mapping, wherein the committed reporting schema mapping produces 17 C.F.R. Part 16 records for wrapped instruments classified as Designated Contract Market contracts, 17 C.F.R. Part 17 records where position size exceeds applicable large-trader thresholds, 17 C.F.R. Part 45 records for wrapped instruments whose treatment attributes classify them as swaps under the jurisdictional rule set, and equivalent foreign regulatory records where applicable;
producing, within the hardware trusted execution environment, a compliance attestation record cryptographically signed by the hardware-rooted attestation key and binding the wrapped instrument definition attributes and capital treatment attributes to the contents of the hardware measurement register, to a cryptographic commitment over the ingested records, and to a cryptographic commitment over the committed rule sets and methodology parameters; and
exporting the wrapped instrument definition, the capital treatment attributes, the regulatory reporting records, the compliance attestation record, and a methodology disclosure record in a form independently verifiable by a regulator or institutional counterparty against a hardware-vendor attestation service without participation of, or reliance on representations by, an operator of the prediction market exchange, thereby producing compliance outputs whose rule-set integrity, input-record integrity, and methodological integrity are cryptographically verifiable by a third party in a manner unobtainable by software-only compliance processing on a generic computer.

9. The method of claim 8, wherein the applying step further comprises integrating surveillance findings from a companion hardware-attested trade integrity system and signal-weighted probability outputs from a companion verified prediction confidence scoring engine to perform risk-adjusted screening, including adjustment of the composite risk score based on account-linkage fingerprints from the companion trade integrity system and based on insider-risk indicators computed at a configured z-score threshold by the companion scoring engine, and wherein the mapping step further comprises adjusting the wrapped instrument definition to reflect insider-risk-flagged position exclusion or downweighting.

10. The method of claim 8, wherein the mapping step further comprises enforcing position limits and concentration controls identified in the jurisdictional rule set based on attested data from the companion systems, and wherein the assigning step computes the replacement cost, the potential future exposure, and the exposure at default under the capital mapping methodology, committing the capital mapping methodology version, the committed supervisory factor table version, the committed alpha multiplier, and the committed netting determination to the compliance attestation record.

11. The method of claim 8, further comprising generating and exporting, together with the compliance attestation record, a zero-knowledge proof attesting that the wrapped instrument was produced according to the committed compliance rules and with the committed rule-set versions on participant records consistent with an external commitment, without disclosing participant-level data or individual position-size information to the recipient, in compliance with applicable privacy law including without limitation the California Consumer Privacy Act and equivalent foreign statutes.

12. The method of claim 8, further comprising formatting the regulatory reporting records for delivery under the committed reporting schema mapping, said delivery comprising (i) where the treatment attributes of the wrapped instrument classify it as a contract traded on a Designated Contract Market, delivery to a trade and volume reporting endpoint in accordance with 17 C.F.R. Part 16, (ii) where the position size exceeds applicable large-trader thresholds identified in the committed reporting schema mapping, delivery to a large-trader reporting endpoint in accordance with 17 C.F.R. Part 17, and (iii) where the treatment attributes classify the wrapped instrument as a swap under the jurisdictional rule set, delivery to at least one CFTC-registered Swap Data Repository in accordance with 17 C.F.R. Part 45, and producing, together with each such delivered record, a hardware-attestation quote binding the delivered record to the compliance attestation record and to the applicable reporting schema version, wherein the hardware-attestation quote is independently verifiable by the recipient repository or endpoint against the hardware-vendor attestation service.

13. The method of claim 8, further comprising sealing compliance state, including wrapped instrument definitions, compliance attestation records, and committed rule-set versions, to the hardware identity of the hardware trusted execution environment such that said compliance state cannot be accessed or modified outside the hardware trusted execution environment, and producing periodic state-attestation quotes binding the sealed compliance state to the measurement of the compliance code base, enabling detection of external manipulation of the sealed compliance store, wherein each compliance attestation record comprises, in a format verifiable against the hardware-vendor attestation service: a hardware measurement register value bound to the compliance code base; a hardware-vendor-signed chain-of-trust certificate; a cryptographic hash of the native contract specifications, a cryptographic hash of the position records, and a cryptographic commitment over the participant-identity records; a cryptographic commitment over the committed rule sets and methodologies in force; a terminal rule identifier and priority rank of a jurisdictional decision tree applied during the computation; a cryptographic hash of the wrapped instrument definition attributes and assigned capital treatment attributes; a cryptographic hash of the regulatory reporting records; and a schema-transformation log identifying, for each field of the regulatory reporting records, a source field, a transformation function identifier, and a cryptographic hash of the transformed value; a nonce and a timestamp, each bound to the other fields; and a signature over the foregoing fields produced using the hardware-rooted attestation key.

14. A non-transitory computer-readable medium storing program instructions that, when executed within a hardware trusted execution environment of a computer system, cause the hardware trusted execution environment to perform operations comprising:
loading a measured compliance code base such that the contents of a hardware measurement register of the hardware trusted execution environment cryptographically bind to the loaded code base upon instantiation;
receiving, over encrypted channels terminating at endpoints within the hardware trusted execution environment, native prediction market contract specifications, associated position records, and participant-identity records, wherein the participant-identity records received into the hardware trusted execution environment comprise plaintext know-your-customer attestation data sufficient to perform the applying operation below, and wherein participant-identity records referenced in the compliance attestation record and in any record exported from the hardware trusted execution environment comprise pseudonymized identifiers derived from cryptographic hashes of the plaintext know-your-customer attestation data, such that plaintext of said records is not exposed outside the hardware trusted execution environment within the wrapper operator's environment during a computation interval;
applying, within the hardware trusted execution environment, know-your-customer, anti-money-laundering, sanctions, and eligibility screening against a committed rule set sealed to the hardware identity of the hardware trusted execution environment to produce a screened record with a composite risk score and a disposition indicator;
mapping, within the hardware trusted execution environment, the native prediction market contract to a wrapped instrument definition with institution-specific treatment attributes assigned under a jurisdictional rule set, wherein the treatment attributes identify the regulatory designation applicable to the contract under the Commodity Exchange Act, the Securities Exchange Act of 1934, or an equivalent foreign regulatory regime as determined by the jurisdictional rule set in force during the computation;
assigning, within the hardware trusted execution environment, institution-specific capital treatment attributes to the wrapped instrument definition under a capital mapping methodology, wherein in one embodiment the capital mapping methodology comprises a replacement cost component, a potential future exposure component computed under the Standardized Approach for Counterparty Credit Risk using a committed supervisory factor table and a committed alpha multiplier, and an exposure at default value, with netting applied under a committed netting determination;
generating, within the hardware trusted execution environment, regulatory reporting records under a committed reporting schema mapping, wherein the committed reporting schema mapping produces records under 17 C.F.R. Part 16, 17 C.F.R. Part 17 where applicable large-trader thresholds are exceeded, and 17 C.F.R. Part 45 where the treatment attributes classify the wrapped instrument as a swap under the jurisdictional rule set, or equivalent foreign regulatory schemas;
producing a compliance attestation record cryptographically signed by a hardware-rooted attestation key of the hardware trusted execution environment and binding the wrapped instrument definition attributes to the contents of the hardware measurement register, to a cryptographic commitment over the received records, and to a cryptographic commitment over the committed rule sets and methodology parameters; and
causing export of the wrapped instrument definition, the regulatory reporting records, the compliance attestation record, and a methodology disclosure record in a form independently verifiable against a hardware-vendor attestation service without participation of, or reliance on representations by, an operator of the prediction market exchange, wherein the claimed combination of hardware-sealed rule-set storage, trusted-execution-environment-bound compliance processing, and cryptographic attestation anchored in the hardware-rooted attestation key produces compliance outputs whose rule-set integrity, input-record integrity, and methodological integrity are cryptographically verifiable by a third party in a manner unobtainable by software-only compliance processing on a generic computer.

15. The non-transitory computer-readable medium of claim 14, wherein the operations further comprise receiving surveillance findings from a companion hardware-attested trade integrity system and signal-weighted probability outputs from a companion verified prediction confidence scoring engine, incorporating the received surveillance findings into the composite risk score and the received signal-weighted probability outputs as risk adjustments applied by the capital treatment mapping operations, and producing a hardware-attestation quote binding the integrated outputs to the measurement of the compliance code base and to the identities and attestation quote references of the companion systems.

16. The non-transitory computer-readable medium of claim 14, wherein the compliance attestation record produced by the operations comprises, in a format verifiable against the hardware-vendor attestation service: (a) a hardware measurement register value produced by hardware upon instantiation of the compliance code base, bound to the loaded code base such that any modification of the code base produces a different measurement register value; (b) a hardware-vendor-signed chain-of-trust certificate bound to the hardware identity of the hardware trusted execution environment; (c) a cryptographic hash of the received native contract specifications, a cryptographic hash of the received position records, and a cryptographic commitment over the received participant-identity records; (d) a cryptographic commitment over the committed rule sets and committed methodologies in force during the computation, including at least the committed KYC/AML rule-set version, the committed jurisdictional rule-set version, the capital mapping methodology version, the committed supervisory factor table version, the committed alpha multiplier, the committed netting determination, and the committed reporting schema mapping version; (e) a terminal rule identifier and priority rank of a jurisdictional decision tree applied during the computation, a cryptographic hash of the wrapped instrument definition attributes and assigned capital treatment attributes, and a cryptographic hash of the regulatory reporting records produced during the computation, and a schema-transformation log identifying, for each field of the regulatory reporting records, a source field, a transformation function identifier, and a cryptographic hash of the transformed value; (f) a verifier-supplied or self-generated nonce and a timestamp, each bound to the other fields of the compliance attestation record; and (g) a signature over the foregoing fields produced using the hardware-rooted attestation key.

17. The non-transitory computer-readable medium of claim 14, wherein the operations further comprise committing the compliance attestation record and the wrapped instrument definition to a tamper-evident ledger organized as a Merkle accumulator whose root is periodically published to an external public commitment channel comprising at least one of a public blockchain, a regulator-operated commitment endpoint, and a consortium-operated commitment channel.

18. The non-transitory computer-readable medium of claim 17, wherein the operations further support verification by a relying party of the temporal integrity of a past compliance attestation record, said verification comprising (i) obtaining from the tamper-evident ledger a Merkle inclusion proof for a record containing the past compliance attestation record, (ii) verifying said inclusion proof against a published Merkle accumulator root obtained from the external public commitment channel, (iii) verifying the compliance attestation record against the hardware-vendor attestation service, and (iv) upon successful verification of both the Merkle inclusion proof and the compliance attestation record, confirming that the compliance attestation record was produced by the identified compliance code base at the indicated past production time and has not been retroactively altered, wherein said verification is performable without participation of, or reliance on representations by, the operator of the prediction market exchange.

19. The non-transitory computer-readable medium of claim 14, wherein the operations further comprise generating and exporting, together with the compliance attestation record, a zero-knowledge proof attesting that the wrapped instrument definition was produced by the committed compliance rules on participant records consistent with an external commitment, without disclosing participant-level data or individual position sizes to the recipient, in compliance with applicable privacy law including without limitation the California Consumer Privacy Act and equivalent foreign statutes.

20. The non-transitory computer-readable medium of claim 14, wherein the prediction market exchange operates under at least one of (i) designation as a Designated Contract Market under the Commodity Exchange Act, (ii) an intermediated Designated Contract Market designation permitting futures-commission-merchant intermediation, (iii) registration as a securities exchange under the Securities Exchange Act of 1934, and (iv) an equivalent foreign regulatory designation, and wherein the operations further comprise cross-portfolio integration with companion applications addressing prediction market trade integrity and signal-weighted probability computation supporting documentation for compliance with DCM Core Principles 3, 4, and 12, CFTC Rule 180.1, applicable Basel capital framework obligations, and applicable U.S. federal banking agency model risk management supervisory guidance.
